(19) United States
(12) Patent Application Publication
(10) Pub. No.: US 2011/0222949 A1
(43) Pub. Date: Sep. 15, 2011

(54) MEDIUM TRANSPORTING APPARATUS AND RECORDING APPARATUS

(75) Inventors: Akinobu NAKAHATA, Shiojiri-shi (JP); Yoshiyuki TAKEDA, Shiojiri-shi (JP); Hiroyuki SUGIMOTO, Matsumoto-shi (JP)

(73) Assignee: SEIKO EPSON CORPORATION, Tokyo (JP)

(21) Appl. No.: 13/045,912

(22) Filed: Mar. 11, 2011

(30) Foreign Application Priority Data
Mar. 12, 2010 (JP) 2010-055471

(51) Int. Cl. B41J 11/02; B65H 3/06

(52) U.S. Cl. 400/611; 271/117

(57) ABSTRACT

A medium transporting apparatus includes a placement section, a transport unit, and a separation unit having an inclined surface, wherein the transport unit includes a transport roller that can be moved in a transport direction, a force to move the transport roller to the upstream side in the transport direction is applied from a medium to the transport roller as a counteracting force against a force for the transport roller to transport the medium to the downstream side in the transport direction, and when the counteracting force becomes larger than a predetermined force, the transport roller is moved to the upstream side in the transport direction by the counteracting force.

### CROSS REFERENCES TO RELATED APPLICATIONS

The entire disclosure of Japanese Patent Application No. 2010-055471, filed Mar. 12, 2010 is expressly incorporated herein by reference.

### BACKGROUND

1. Technical Field

The present invention relates to a medium transporting apparatus including a placement section in which media to be transported is placed, a transport unit that is in contact with a medium to be transported which is located uppermost in a stacking direction of the media to be transported placed in the placement section and transports the medium to be transported to a downstream side in a transport direction, and a separation unit that is provided on the downstream side of the transport unit, has an inclined surface which is inclined with respect to the side view posture of the medium to be transported placed in the placement section, and separates the medium to be transported uppermost with respect to the transport unit from the next and subsequent media to be transported when the top edges which are the downstream ends of the media to be transported that are transported by the transport unit come into contact with the inclined surface, and also relates to a recording apparatus including the medium transporting apparatus.

In this application, the recording apparatus includes various types of recording apparatuses such as an ink jet printer, a wire dot printer, a laser printer, a line printer, a copier, and a facsimile.

2. Related Art

In the related art, as shown in JP-A-2003-48640, a sheet feeder as a medium transporting apparatus includes a paper cassette in which paper sheets are placed, a main body that contains the paper cassette, and a paper feed roller provided in the main body. A position adjustment unit for switching the position of the paper cassette with respect to the main body is provided in either the main body or the paper cassette. The position adjustment unit is provided so that a user switches the position adjustment unit in accordance with a rigidity of the paper sheet. Therefore, both a thin paper sheet and a thick paper sheet having rigidities different from each other can be transported.

However, the user has to manually perform the switching operation, or manually perform setting on a driver, or manually perform setting of the paper sheet on the printer, so that there is a risk that an operation error occurs. If the switching operation is automated, a driving mechanism is required and the structure will be complicated. Also, there is a risk that the cost increases.

Therefore, in the related art, as shown in JP-A-2003-146455, there is a configuration in which a sheet feeder as a medium transporting apparatus includes two feed rollers in a transport direction.

However, if a plurality of feed rollers are provided, there is a risk that the cost increases. Also, there is a risk that the user makes an error in the operation to select the feel roller. If the selection operation is automated, a detector, a switching mechanism, and a driving mechanism are required and the structure will be complicated. Further, there is a risk that the cost increases.

The invention is made in view of the above situation, and an object of the invention is to provide a medium transporting apparatus in consideration of a multi-feed problem and a non-feed problem in a case in which rigidities of media to be transported are different, and to provide a recording apparatus including the medium transporting apparatus.

### SUMMARY

To achieve the above-described object, a medium transporting apparatus according to a first aspect of the invention is a medium transporting apparatus that transports a medium placed in a placement section from the placement section to a downstream side in a transport direction, and the medium transporting apparatus includes a transport unit that has a transport roller which is in contact with the medium placed in the placement section and located uppermost in a stacking direction and can be moved, and transports the medium to the downstream side by driving the transport roller, and a separation unit that is provided on the downstream side of the transport unit, has an inclined surface which is inclined with respect to a side view posture of the medium placed in the placement section, and separates the uppermost medium with respect to the transport unit from the next and subsequent media when the top edges of the media transported by the transport unit come into contact with the inclined surface, wherein, as a counteracting force against a force for the transport roller to transport the medium to the downstream side, a force to move the transport roller to the upstream side in the transport direction is applied to the transport roller, and when the counteracting force becomes larger than a predetermined force, the transport roller is moved from an initial position to the upstream side in the transport direction by the counteracting force.

According to the first aspect of the invention, it is possible to move the transport roller in accordance with the resilience of the medium to be transported. Also, it is possible to extend the distance from the surface of the separation unit to the contact point between the transport roller and the medium to be transported in accordance with the resilience of the medium to be transported. Base on this, the medium to be transported can be easily bent. Based on this, for example, the frictional resistance generated between the surface and the top edge of the medium to be transported when the top edge hits the surface can be smaller than that in a case in which the medium to be transported is not bent. As a result, the transport load necessary for the top edge of the medium to be transported to pass through the separation unit can be small.

Thus, it is possible to handle media to be transported having different rigidities without an operation by a user.

A second aspect of the invention is the medium transporting apparatus according to the first aspect of the invention, in which the transport unit includes an arm mechanism that rotatably holds the transport roller at one end and swings around the other end, the arm mechanism is configured to change a distance from the center of the swing movement to the transport roller, and the transport unit further includes a unit which, when the distance in a state in which the transport roller is moved by the counteracting force is shorter than the distance in a state in which the transport roller is at the initial position, applies a force to return the transport roller to the initial position.

According to the second aspect of the invention, in addition to the same operational effect as that in the first aspect, when the transport roller moves to the upstream side, the top end of the arm mechanism swings as if the top end dug into the uppermost medium to be transported. At this time, when the top end tries to dig into the medium to be transported, it is possible to increase the pressing force of the transport roller to the medium to be transported. In other words, it is possible to increase the vertical resistance between the transport roller and the uppermost medium to be transported.

As a result, it is possible to increase the transport force that is a force for the transport roller to transport the medium to be transported to the downstream side in the transport direction.

The configuration in which the distance of the arm mechanism changes may be a configuration in which an portion between the center of the swing movement of the arm mechanism and the transport roller bends, or a configuration in which a plurality of members relatively slide to extend or contract.

A third aspect of the invention is the medium transporting apparatus according to the second aspect of the invention, in which the arm mechanism includes a first arm section that swings around the other end, and a second arm section that swings around the transport roller, and the transport roller moves to the upstream side in the transport direction by increasing an amount of bending at a portion where the first arm section and the second arm section are connected to each other.

According to the third aspect of the invention, in addition to the same operational effect as that in the second aspect, it is possible to increase the amount of bending of the arm mechanism between the first arm section and the second arm section by the counteracting force.

In a state before the transport roller is moved by the counteracting force, the arm mechanism may bend or not bend. This is because the same operational effect can be obtained in either case. Specifically, only the amount of bending has to increase when the transport roller moves to the upstream side in the transport direction, and in a state before the transport roller moves, whether the arm mechanism bends or not makes no difference.

A fourth aspect of the invention is the medium transporting apparatus according to the third aspect of the invention, which further includes, as a unit that applies a force to return the transport roller to the initial position, a first spring that applies a force, when an amount of bending between the first arm section and the second arm section becomes large, in a direction to return a posture of the first arm section to a posture when the amount of bending is small.

According to the fourth aspect of the invention, in addition to the same operational effect as that in the third aspect, when the amount of bending increases, it is possible to increase the force for the transport roller to press the uppermost medium to be transported by the urging force of the first spring. This is because, as the distance decreases, the amount of elastic deformation of the first spring increases. Therefore, it is possible to increase the transport force. As a result, it is possible to further reliably transport the medium to be transported having high resilience.

In addition, it is possible to return the posture of the arm mechanism to the original posture after transporting the medium to be transported.

A fifth aspect of the invention is the medium transporting apparatus according to the third aspect of the invention, which further includes, as a unit that applies a force to return the transport roller to the initial position, a second spring that applies a force, when an amount of bending between the first arm section and the second arm section becomes large, in a direction to return a posture of the first arm section and the second arm section to a posture when the amount of bending is relatively small.

According to the fifth aspect of the invention, in addition to the same operational effect as that in the third aspect, it is possible to move the position of the transport roller in accordance with the rigidity of the medium to be transported by appropriately setting the strength of the urging force of the second spring. Specifically, it is possible to set a desired distance to a distance from the surface of the separation unit to the contact point between the transport roller and the medium to be transported in accordance with the degree of rigidity of the medium to be transported.

A sixth aspect of the invention is the medium transporting apparatus according to the third aspect of the invention, in which the transport unit further includes a gear train that transmits power from the first arm section to the transport roller of the second arm section, and the first arm section and the second arm section bend around an Nth gear (N is an even number) counted from a gear of a shaft of the transport roller including the gear of the shaft.

According to the sixth aspect of the invention, in addition to the same operational effect as that in any one of the third to the fifth aspects, it is possible to apply a force to the second arm section on the basis of the first arm section in a direction in which the transport roller approaches the medium to be transported by a power transmission. Therefore, as the angle of bending (the amount of bending) increases, the force by which the transport roller presses the medium to be transported can be increased.

A seventh aspect of the invention is the medium transporting apparatus according to the sixth aspect of the invention, in which as a medium to be transported, a first medium and a second medium having a rigidity higher than that of the first medium can be transported, and when a moment by the counteracting force which the transport roller receives from the medium to be transported is defined as M1, a moment by a force applied to the first arm section by a gear at a position where the first arm section and the second arm section bend is defined as M2, and a moment by a force that reduces an amount of bending between the first arm section and the second arm section is defined as M3, the following relationship is established: when the medium to be transported is the first medium, M3≧M1+M2, and when the medium to be transported is the second medium, M3<M1+M2.

According to the seventh aspect of the invention, in addition to the same operational effect as that in the sixth aspect, it is possible to more reliably handle the first medium and the second medium because the above relationship is established. In other words, it is possible to reliably transport both media to be transported.

A recording apparatus according to an eighth aspect of the invention includes the medium transporting apparatus according to the first aspect of the invention, and a recording section that performs recording on the medium transported by the medium transporting apparatus. Based on this, in the recording apparatus, the same operational effect as that of the first aspect of the invention can be obtained.

### BRIEF DESCRIPTION OF THE DRAWINGS

The invention will be described with reference to the accompanying drawings, wherein like numbers reference like elements.

FIG. 1 is a side view showing an outline of a printer according to the invention.

FIG. 2 is a main portion enlarged perspective view showing an outline of a medium transport unit according to the invention.

FIGS. 3A and 3B are schematic side views showing a state of the medium transport unit when transporting a thin paper sheet.

FIGS. 4A and 4B are schematic side views showing a state of the medium transport unit when transporting a thick paper sheet.

FIGS. 5A and 5B are side views showing an outline of a medium transport unit according to another embodiment.

### DESCRIPTION OF EXEMPLARY EMBODIMENTS

Hereinafter, embodiments of the invention will be described with reference to the drawings.

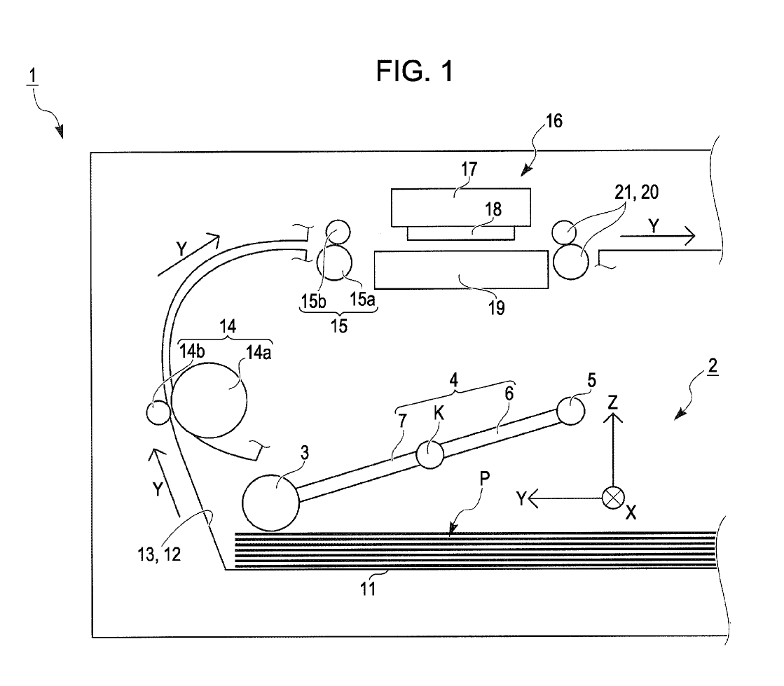

FIG. 1 is a side view showing an outline of a printer which is an example of a recording apparatus according to the invention.

As shown in FIG. 1, a printer 1 includes a medium transport unit 2, a transport path, a recording section 16, and a discharge section 20.

Among them, the medium transport unit 2 is provided so that a paper sheet P, which is an example of a medium to be transported, can be transported in the transport direction Y direction. The transport path is formed by a medium guiding section which guides the paper sheet P transported by the medium transport unit or the like. The transport path shows a path through which the paper sheet P is transported.

The recording section 16 is configured to be able to perform recording on the paper sheet P transported by the medium transport unit 2. Further, the discharge section 20 is provided so that the recorded paper sheet P can be discharged and placed on a discharge tray (not shown FIG. 1).

Specifically, the medium transport unit 2 includes a placement section 11, a pick-up roller 3, an arm mechanism 4, a separation unit 12, a first roller pair 14, and a second roller pair 15. Among them, the placement section 11 is provided so that the paper sheets P are placed. The pick-up roller 3 can be driven by a motor power. The pick-up roller 3 is provided to be able to contact with the paper sheet P uppermost in the stacking direction among the paper sheets P stacked in the placement section 11. The arrow of Z axis indicates upside in the stacking direction.

Further, the arm mechanism 4 is provided to be able to swing around a swinging shaft 5 which is at one end of the arm mechanism 4 located on the upstream side in the transport direction. The arm mechanism 4 is configured to rotatably hold the pick-up roller 3 at the other end located on the downstream side in the transport direction. As described below in detail, the arm mechanism 4 includes a first arm section 6 and a second arm section 7, and the arm mechanism 4 is provided to be able to bend at a bend point K which is the connection point between the first arm section 6 and the second arm section 7.

The motor may be provided in the base body of the printer 1 separate from the arm mechanism 4, or may be provided on the arm mechanism 4. In the former case, the motor power is transmitted to the pick-up roller 3 by a power transmission unit such as a gear train through the swinging shaft 5. On the other hand, in the latter case, the motor power is transmitted to the pick-up roller 3 by a power transmission unit such as a gear train not through the swinging shaft 5.

The separation unit 12 is provided on the downstream side in the transport direction of the position where the paper sheets P are set in the placement section 11. Specifically, the separation unit 12 has an inclined surface 13 which is inclined with respect to a side view posture of the paper sheet P transported by the pick-up roller 3. The separation unit 12 is provided so that if the paper sheets P are multi-fed, the paper sheet P uppermost with respect to the pick-up roller 3 can be separated from the next and following paper sheets P. The separation unit 12 is a so-called bank separation mechanism.

Here, the “bank separation mechanism” is a mechanism for separating the paper sheets P by applying a load to the top edges of the paper sheets P by setting a surface with respect to which the paper sheets P are transported at a certain angle.

Further, the first roller pair 14 and the second roller pair 15 are provided so that the paper sheet P that has passed through the separation unit 12 can be transported to the recording section 16. Among them, the first roller pair 14 includes a first drive roller 14a and a first driven roller 14b.

A so-called retard roller, which rotates with a predetermined amount of load, may be used instead of the first driven roller 14b. In this case, if the separation at the bank separation mechanism is not sufficient, the multi-fed paper sheets P can be reliably separated. Specifically, the paper sheet that is directly in contact with the first drive roller 14a can be separated from the other paper sheets on the retard roller side.

The second roller pair 15 is provided on the downstream side of the first roller pair 14 in the transport path. Specifically, the second roller pair 15 includes a second drive roller 15a and a second driven roller 15b. The second roller pair 15 is provided so that the paper sheet P can be transported to the recording section 16 with high accuracy, for example, by means of a stepping motor.

Needless to say, a so-called skew elimination, in which the posture of the paper sheet P is corrected with respect to the transport direction Y, is performed when the top edge of the paper sheet P reaches the second roller pair 15.

The recording section 16 includes a carriage 17, a recording head 18, and a medium support section 19. Among them, the carriage 17 is configured to move in the width direction X of the paper sheet P by a power of a moving unit (not shown in FIG. 1) while being guided by a guide shaft (not shown in FIG. 1) extended in the width direction. The recording head 18 is provided on the carriage 17 so that ink can be discharged to the paper sheet P. A so-called ink jet type recording is performed.

Further, the medium support section 19 is provided in a position facing the recording head 18 and configured to be able to support the paper sheet P and keep the gap between the paper sheet P and the recording head 18 at a predetermined distance.

Although the recording head 16 that discharges ink is employed in this embodiment, another configuration may be used. For example, a configuration of a so-called laser printer, in which toner is attached to the paper sheet P and heat and pressure are applied to the toner on the paper sheet P to perform recording on the paper sheet P, may be used.

The discharge section 20 includes a third roller pair 21 and a discharge tray not shown in FIG. 1. The third roller pair 21 is provided on the downstream side of the recording section 16 in the transport path so that the printed paper sheet P can be transported to the discharge tray.

The placement section 11 of the medium transport unit 2 may have a cassette type configuration in which the placement section 11 can be attached and detached to and from a printer main body, or may have a configuration in which the placement section 11 is integrally formed with the printer main body.

Next, the medium transport unit 2, which is a main portion of the invention, will be described in further detail.

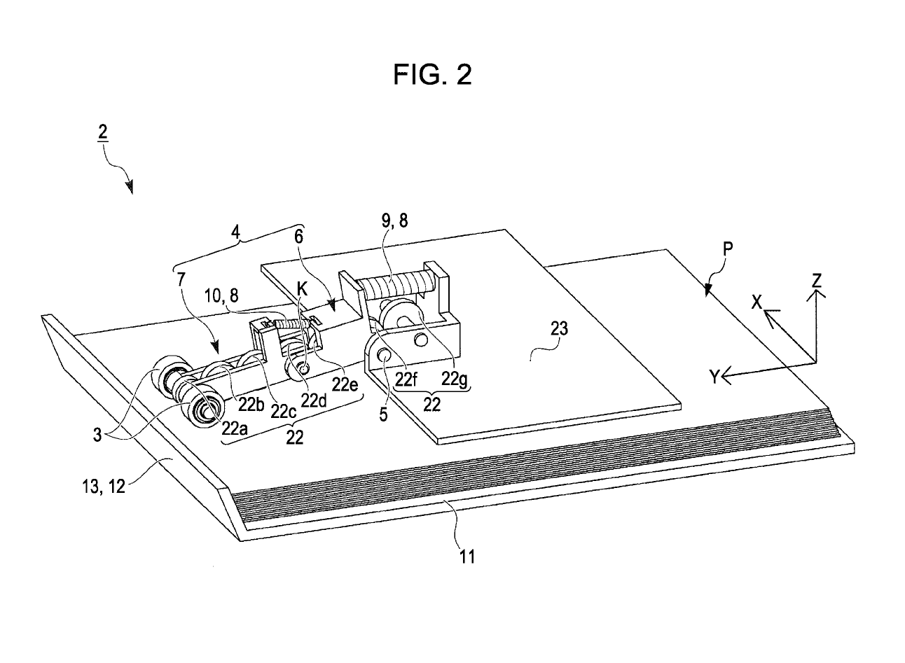

FIG. 2 is a main portion enlarged perspective view showing an outline of the medium transport unit according to the invention.

As shown in FIG. 2, the arm mechanism 4 includes the first arm section 6, the second arm section 7, an urging unit 8, and a gear train section 22 as described above. Among them, the first arm section 6 is provided to be able to swing around the swinging shaft 5. In the arm mechanism 4, a portion near the swinging shaft 5 is located on the upstream side, the upstream end of the second arm section 7 is connected to the downstream end of the first arm section 6, and the first arm section 6 and the second arm section 7 are provided to be able to bend relative to each other at the bend point K. Further, the pick-up roller 3 is rotatably held on the downstream side of the second arm section 7.

As the urging unit 8, a first spring section 9 and a second spring section 10 are provided. Among them, the first spring section 9 presses the first arm section 6 in a direction in which the downstream end of the first arm section 6 approaches the paper sheet P. Specifically, the first spring section 9 is a pressing spring, and one end engages with a base body 23 of the printer 1. The other end engages with the first arm section 6. Therefore, when the first arm section 6 swings in a direction in which the bend point K moves away from the paper sheet P, an urging force in a direction in which the bend point K approaches the paper sheet P can be applied. In other words, an urging force is applied so that the first arm section 6 restores the original posture which is the posture before the first arm section swings.

On the other hand, the second spring section 10 applies a spring force so that the first arm section 6 and the second arm section 7 do not bend relative to each other. Specifically, the second spring section 10 is an extension spring, and one end engages with the first arm section 6. The other end engages with the second arm section 7.

Here, in a state in which the first arm section 6 and the second arm section 7 do not bend to each other, a first limiting section (not shown in FIG. 2) formed in the first arm section comes into contact with a second limiting section (not shown in FIG. 2) formed in the second arm section.

Based on this, it is assumed that the first arm section 6 and the second arm section 7 are configured not to bend in one direction. On the other hand, it is assumed that the first arm section 6 and the second arm section 7 are provided so as to be able bend in the other direction against the spring force of the second spring section 10.

Therefore, when the first arm section 6 and the second arm section 7 bend in the other direction at the bend point K, it is possible to apply a spring force so that the first arm section 6 and the second arm section 7 come in a state in which the first arm section 6 and the second arm section 7 do not bend. Or, the spring force is applied so that the amount of bending is small. In other words, the spring force is applied so that the original posture before being bent is restored. In this embodiment, it is configured so that, when the arms bend, the spring force is applied in a direction in which the bend point K approaches the paper sheet P.

The gear train section 22 is provided so that the power of the motor provided in the base body can be transmitted to the pick-up roller 3. Specifically, the gear train section 22 includes a first gear 22a to a seventh gear 22g. Among them, the first gear 22a is provided integrally with the shaft of the pick-up roller 3, and engages with the second gear 22b. On the other hand, the seventh gear 22g is provided in the base body, and engages with the sixth gear 22b provided on the swinging shaft of the first arm section 6.

Here, when the paper sheet P is transported to the downstream side, the rotation direction of the seventh gear 22g when driving the pick-up roller 3 is the same as the rotation direction of the pick-up roller 3. The above operation is to apply a force to the first arm section 6 so that the downstream end of the first arm section 6 approaches the paper sheet P.

The fifth gear 22e engages with the sixth gear 22f and the fourth gear 22d, and transmits the power to the fourth gear 22d. The third gear 22c engages with the fourth gear 22d and the second gear 22b, and transmits the power to the second gear 22b.

Here, in the gear train section 22, the Nth gear (N is an even number) counting from the first gear 22a provided on the shaft of the pick-up roller 3 is configured to be located on the bend point. This is because the fifth gear 22e applies a force to the second arm section 7 so that the downstream end of the second arm section 7 approaches the paper sheet P in the same manner as the action in which the seventh gear 22g applies a force to the first arm section 6. As described below in detail, the larger the angle of the bend is, the larger the force for the pick-up roller to press the paper sheet P can be.

Next, an operation of the arm mechanism 4 according to the invention will be described in further detail.

When transporting a thin paper sheet (first medium)

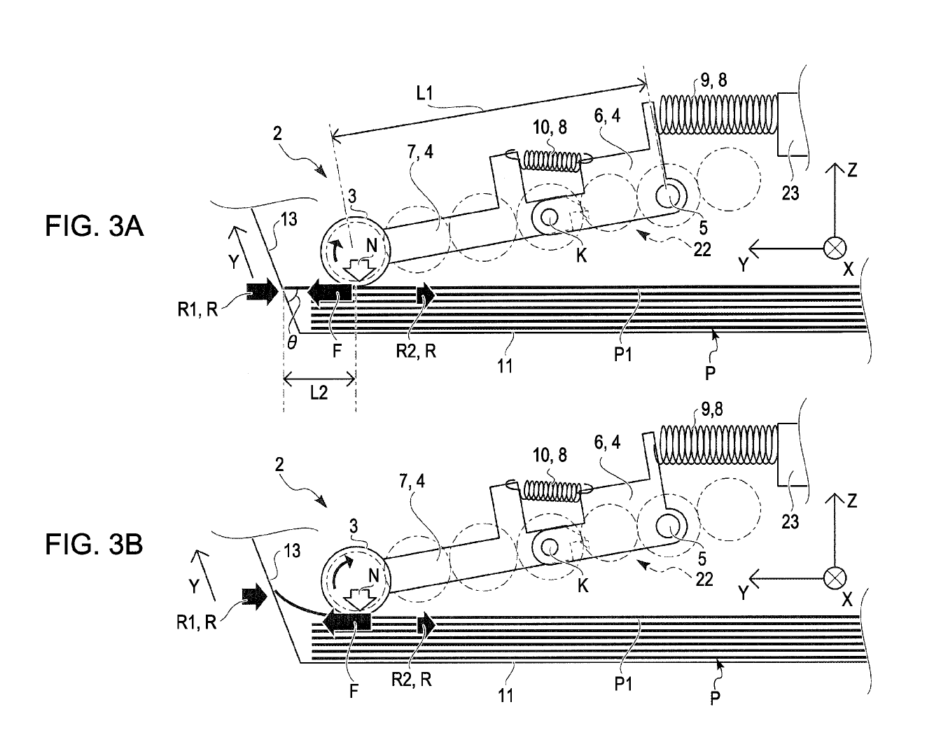

FIGS. 3A and 3B are schematic side views showing a state of the medium transport unit when transporting a thin paper sheet. FIG. 3A shows a state in which the top edge of the thin paper sheet is in contact with the inclined surface. On the other hand, FIG. 3B shows a state in which the thin paper sheet is transported further.

Here, the “thin paper sheet” means a type of paper sheet having a relatively small thickness and a relatively low resilience. The thin paper sheet is general plain paper. The thin paper sheet is a subordinate concept of the “first medium” which is a medium having a relatively low resilience.

As shown in FIG. 3A, when the pick-up roller 3 rotates in a clockwise direction in FIG. 3A, the uppermost thin paper sheet P1 can be transported to the downstream side in the transport direction. Here, a transport load which is a load to transport the paper sheet P to the downstream side in the transport direction is defined as R, and a transport force which the pick-up roller 3 applies to the paper sheet P is defined as F.

The transport force F can be obtained from a friction coefficient μ1 between the pick-up roller 3 and the paper sheet P and a pressing force N by which the pick-up roller 3 presses the paper sheet P.

In the transport load R, a reaction force which the paper sheet P receives from the inclined surface 13 is defined as R1, and a friction force (frictional resistance) between the uppermost paper sheet P and the next paper sheet P is defined as R2. The friction force R2 can be obtained from a friction coefficient μ2 between the paper sheet P and the paper sheet P and the pressing force N.

In this case, in a stage before the top edge of the paper sheet P hits the inclined surface 13 of the separation unit 12, although the friction force R2 between the uppermost paper sheet and the next paper sheet is applied, the friction force R2 is small. In other words, the friction force R2 is significantly smaller than a load R1 described below generated when the top edge of the paper sheet P hits the inclined surface 13 of the separation unit 12. Therefore, in the stage before the top edge hits the inclined surface 13, the transport load R is small.

Then the thin paper sheet P1 approaches the inclined surface 13 at an approach angle θ and hits the inclined surface 13.

At this time, the reaction force R1 is generated by the hitting, so that the transport load R increases. Here, regarding the uppermost thin paper sheet P1, the friction coefficients μ1, μ2, the inclined surface, and the like are formed so that the relationship described below is established.

Transport load R<transport force F

specifically

Reaction force R1+friction force R2<transport force F

On the other hand, regarding the next and subsequent thin paper sheets P1, the friction coefficients μ1, μ2, the inclined surface, and the like are formed so that the relationship described below is established.

Transport load R>transport force F

Therefore, even if the next and subsequent thin paper sheets P1 are transported to the downstream side in the transport direction along with the uppermost thin paper sheet P1, the top edges of the next and subsequent thin paper sheets P1 can be stopped at the inclined surface 13. In other words, the next and subsequent thin paper sheets P1 can be separated from the uppermost thin paper sheet P1.

When the top edges of the thin paper sheets P1 hit the inclined surface 13 and the transport load R is generated, a force toward the upstream side in the transport direction is largely applied to the pick-up roller 3 as a counteracting force. Here, the arm mechanism 4 is configured to swing around the swinging shaft 5 which is located on the upstream side of the pick-up roller 3 and above the uppermost thin paper sheet P1 in the stacking direction. Therefore, a force that integrally swings the first arm section 6 and the second arm section 7 in a direction in which the downstream end of the second arm section 7 which is the free end of the arm mechanism 4 at which the pick-up roller 3 is provided approaches the thin paper sheet P1.

However, in a case of the thin paper sheet P1, the resilience of the paper sheet is low, so that the force toward the upstream side in the transport direction as a counteracting force applied to the pick-up roller 3 is smaller than that in a case of a second medium (P2) described below. Therefore, the force that integrally swings the first arm section 6 and the second arm section 7 is smaller than that in the case of the second medium (P2) described below.

Here, the first arm section 6 and the second arm section 7 are configured to be able to bend at the bend point K as described above. In the case of the thin paper sheet P1, the force toward the upstream side in the transport direction as the counteracting force is small, so that the first arm section 6 and the second arm section 7 do not bend at the bend point K.

Specifically, the first arm section 6 and the second arm section 7 are configured to bend at the bend point K when the force toward the upstream side in the transport direction as the counteracting force becomes larger than a predetermined force. More specifically, in this embodiment, a moment by a counteracting force which a transport roller receives from the paper sheet P is defined as M1, a moment by a reaction force applied to the gear on the bend point is defined as M2, and a moment by a spring force of the second spring section 10 applied in a direction in which M1 and M2 are cancelled (a direction in which the bend is straightened), the weights of the first arm section 6 and the second arm section 7, and the like is defined as M3.

In the case of the thin paper sheet P1, the spring force of the second spring section 10 and the like are determined so that the relationship described below is established.

Moment M3 in a direction in which M1 and M2 are cancelled≧moment M1 by the counteracting force+moment M2 by the reaction force on the bend position

Therefore, in the case of the thin paper sheet P1 (the first medium), the first arm section 6 and the second arm section 7 do not bend at the bend point K. The pick-up roller 3 does not move in the transport direction Y. In other words, the distance L1 from the pick-up roller 3 to the swinging shaft 5 does not change. Also, the distance L2 from the inclined surface 13 to the contact point between the pick-up roller 3 and the paper sheet P does not change.

As shown in FIG. 3B, since the resilience of the paper sheet is low, the top edge of the thin paper sheet P1 bends and goes up along the inclined surface 13. The relationship described below is established.

Transport load R<transport force F

Based on this, the thin paper sheet P1 can be further transported to the downstream side in the transport direction.

When transporting a thick paper sheet (second medium)

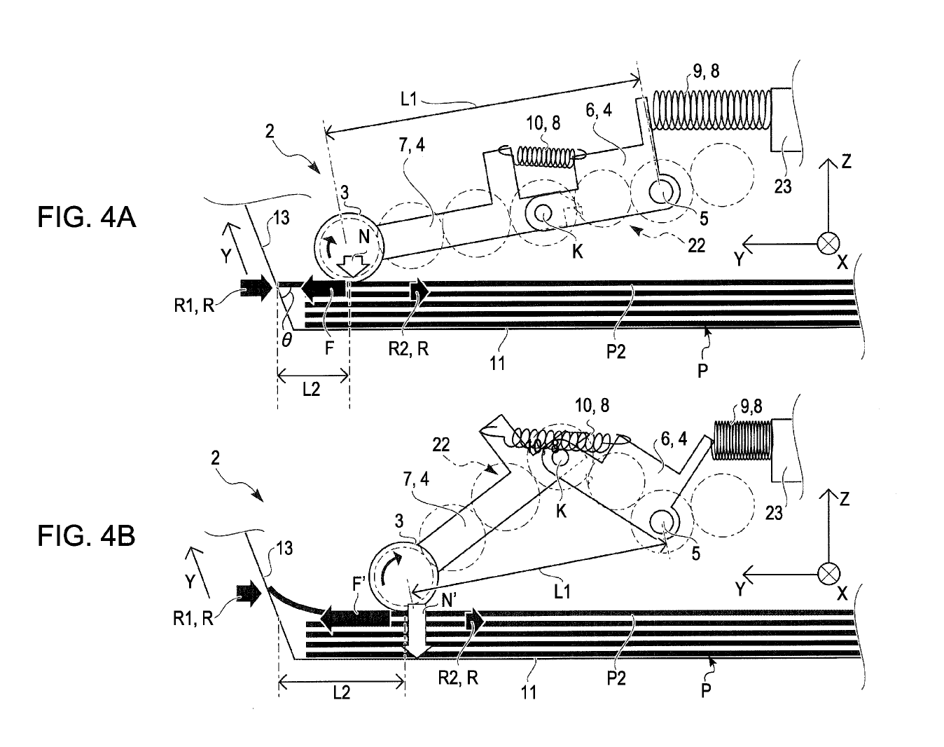

FIGS. 4A and 4B are schematic side views showing a state of the medium transport unit when transporting a thick paper sheet. FIG. 3A shows a state in which the top edge of the thick paper sheet is in contact with the inclined surface. On the other hand, FIG. 4B shows a state in which the pick-up roller is slightly driven from the state of FIG. 4A.

Here, the “thick paper sheet” means a type of paper sheet having a thickness larger than that of the thin paper sheet and a resilience higher than that of the thin paper sheet. The thick paper sheet is a subordinate concept of the “second medium” which is a medium having a resilience higher than that of the “first medium”.

As shown in FIG. 4A, when the pick-up roller 3 rotates in a clockwise direction in FIG. 4A, the uppermost thick paper sheet P2 can be transported to the downstream side in the transport direction. In the same manner as in the case of the thin paper sheet P1 described above, it is possible to cause the top edge of the thick paper sheet P2 to hit the inclined surface 13. In the same manner as in the case of the thin paper sheet P1 described above, the approach angle when the thick paper sheet P2 hits the inclined surface 13 is θ.

Here, a difference from the case of the thin paper sheet P1 described above is that the resilience of the thick paper P2 is higher than that of the thin paper sheet P1.

Therefore, the reaction force R1 is generated when the top edge of the thick paper sheet P2 hits the inclined surface 13, and the reaction force R1 is significantly larger than that in the case of the thin paper sheet P1. This is because the thick paper sheet P2 has resilience higher than that of the thin paper sheet P1 and needs a large force to be bent. In other words, the transport force increases from when the thick paper sheet P2 hits the inclined surface to when the thick paper sheet P2 is bent, and the amount of increase is larger than that in the case of the thin paper sheet P1. In the same manner as in the case of the thin paper sheet P1, to transport the thick paper sheet P2, the relationship described below needs to be established.

Transport load R<transport force F

in other words,

Reaction force R1+friction force R2<transport force F

Here, the reaction force R1 is significantly larger than that in the case of the thin paper sheet P1. Therefore, a transport force larger than that in the case of the thin paper sheet P1 is required.

A force toward the upstream side in the transport direction is largely applied to the pick-roller 3 as a counteracting force. The force (M1) of the counteracting force is significantly larger than that in the case of the thin paper sheet P1. In the case of the thick paper sheet P1, the spring force of the second spring section 10 and the like are determined so that the relationship described below is established.

Moment M3 in a direction in which M1 and M2 are cancelled<moment M1 by the counteracting force+moment M2 by the reaction force on the bend position

Therefore, as shown in FIG. 4B, the first arm section 6 and the second arm section 7 bend at the bend point K against the spring force of the first spring section 9, the spring force of the second spring section 10, the weights of the first arm section 6 and the second arm section 7, and the like. Specifically, the amount of bend increases when the reaction force R1 becomes larger than a first predetermined force.

In this case, the distance L2 from the inclined surface 13 to the contact point between the pick-up roller 3 and the paper sheet P increases.

Based on this, in an area between the top edge of the thick paper sheet P2 and the contact point between the pick-up roller 3 and the thick paper sheet P2, the thick paper sheet P2 can be bent easier than in the case in which the distance L2 does not change.

As a result, as a first operational effect, the reaction force R1 can be smaller than that in the case in which the distance L2 does not change. In other words, it is possible to reduce the transport load R and make it easy for the top edge of the thick paper sheet P2 to go up along the inclined surface 13.

At the same time, the distance L1 from the swinging shaft 5 to the pick-up roller 3 decreases. In this case, the amount of elastic deformation of the first spring section 9 increases, and the spring force of the first spring section 9 increases. In addition, as described above, the seventh gear 22g applies a force to the first arm section 6 via the sixth gear 22f so that the downstream end of the first arm section 6 approaches the paper sheet P. Because of these, the pressing force N by which the pick-up roller 3 presses the paper sheet P significantly increases.

When the amount of bending at the bend point K reaches a predetermined amount, a third limiting section formed in the first arm section and a fourth limiting section formed in the second arm section come into contact with each other, and thereby the first arm section and the second arm section do not bend any more. In other words, it is configured that the first arm section and the second arm section do not bend any more when the reaction force R1 reaches a second predetermined force. At this time, the first arm section 6 and the second arm section 7 integrally work as a rigid body.

In a state in which the first arm section 6 and the second arm section 7 are balanced by the spring force of the second spring section 10, it is possible to consider that the first arm section 6 and the second arm section 7 are a rigid body which works integrally.

In this case, as a counteracting force, a force to move the pick-up roller 3 to the upstream side in the transport direction is applied. Then, a force that integrally swings the first arm section 6 and the second arm section 7 in a direction in which the downstream end of the second arm section 7 which is the free end of the arm mechanism 4 at which the pick-up roller 3 is provided approaches the thick paper sheet P2.

In a state in which the pick-up roller 3 moves to the upstream side, in other words, in a state in which the distance L1 from the pick-up roller 3 to the swinging shaft 5 decreases, a tilt angle of the arm mechanism 4 with respect to the transport direction Y of the paper sheet P at the point where the pick-up roller 3 is in contact with the thick paper sheet P2 increases.

Therefore, a force which is applied to the arm mechanism 4 so that the pick-up roller 3 tries to dig into the paper sheets P, in other words, a force by which the arm mechanism 4 tries to dig into the paper sheets P, is largely applied. Therefore, the pressing force by which the pick-up roller 3 presses the paper sheet P can be N′ which is significantly larger than the pressing force before the bending.

Here, the above-mentioned “force by which the arm mechanism 4 tries to dig into the paper sheets P” will be described. For example, a case will be considered in which the tilt angle of the arm mechanism 4 varies but the pressing force N is the same when the pick-up roller 3 is not driven.

In such a case, the larger the tilt angle of the line connecting the swinging shaft 5 of the arm mechanism 4 and the pick-up roller 3 with respect to the transport direction Y of the paper sheet P at the point where the pick-up roller 3 is in contact with the thick paper sheet P2 in a range in which the line moves to be vertical, the larger the transport force F when the pick-up roller 3 is driven is. This is because the arm mechanism 4 works as a so-called wedge.

As a result, as a second operational effect, the transport force which the pick-up roller 3 applies to the thick paper sheet P2 can be F′ which is significantly larger than the transport force F before the bending. In other words, by significantly increasing the transport force, it is possible to make it easy for the top edge of the thick paper sheet P2 to go up along the inclined surface 13.

As described above, by employing a configuration in which the pick-up roller 3 automatically moves in the transport direction Y, the uppermost paper sheet P of both the thin paper sheet P1 (first medium) and the thick paper sheet P2 (second medium) can be reliably transported to the recording section 16 via the separation unit 12. As a result, there is no risk that non-feed occurs in which the uppermost paper sheet P of either the thin paper sheet P1 (first medium) or the thick paper sheet P2 (second medium) cannot pass through the separation unit 12. Further, it is not necessary to form a special inclined surface 13 of the separation unit 12. Furthermore, even when the paper sheets P are multi-fed, the separation can be performed on the inclined surface 13 of the separation unit 12.

In other words, the pick-up roller 3 automatically moves in accordance with the rigidity of the paper sheet P, so that a user need not switch setting. There is no troublesome switching operation. Therefore, operation errors by a user can be eliminated.

Further, a sensor for detecting the type of the paper sheet is not necessary, so that it is advantageous in terms of cost. Further, it is not necessary to provide a moving unit for moving the pick-up roller 3 on the basis of the detection result of the sensor. Further, it is not necessary to move a cassette section relative to the pick-up roller 3 to move the position of the paper sheets. Therefore, there is no risk that the apparatus grows in size.

Although, in the above-described embodiment, two types of paper sheets, the thin paper sheet P1 and the thick paper sheet P2 having rigidities different from each other are described as an example, the types of the paper sheets are not limited to two. As a technical idea, only the movement amount of the pick-up roller 3 in the upstream direction has to be changed, and three or more types of paper sheets having different rigidities can be handled. Specifically, when handling a medium having a rigidity higher than that of the thick paper sheet P2, the movement amount of the pick-up roller 3 in the upstream direction should be larger than the movement amount in the case of the thick paper sheet P2. In other words, if the movement amount of the pick-up roller 3 increases in accordance with the rigidity of the medium, it is possible to handle media having rigidities different from each other. It may be a configuration in which the pick-up roller 3 does not move when handling a medium having a lowest rigidity and moves when handling medium having a second lowest rigidity.

If the pick-up roller moves to the upstream side and transports the uppermost thick paper sheet P2, when the top edge of the thick paper sheet P2 reaches the first roller pair 14 and the thick paper sheet P2 is transported by the first roller pair 14, the pick-up roller moves to the downstream side. This is because the large reaction force R1 decreases or disappears. When transporting the next thick paper sheet P2, the pick-up roller 3 moves to the upstream side again as described above.

Although, in this embodiment, a configuration is employed in which the pick-up roller 3 moves in the stacking direction Z in accordance with the number of remaining paper sheets placed in the placement section 11, a configuration may be employed in which the pick-up roller 3 does not move in the stacking direction Z but the placement section 11 moves with respect to the pick-up roller 3. In this case, also the pick-up roller 3 can be moved in the transport direction Y, and the same operational effect can be obtained.

Although, in this embodiment, the arm mechanism 4 does not bend when handling the thin paper sheet P1 and the arm mechanism 4 bends when handling the thick paper sheet P2, it is not limited to this. As a technical idea, when handling the thick paper sheet P2, the distance L1 has to be shorter than that in the case of the thin paper sheet P1, and the distance L2 has to be longer than that in the case of the thin paper sheet P1. Therefore, when handling the thin paper sheet P1, the arm mechanism may bend. This is because only the amount of bending has to increase when handling the thick paper sheet P2.

Although, in this embodiment, the pick-up roller goes down as the number of remaining paper sheets decreases, it is not limited to this. A configuration may be employed in which the pick-up roller does not move in the stacking direction and the placement section moves upward. This is because the same operational effect can be also obtained in this case.

The transport unit 2 as the medium transporting apparatus according to this embodiment includes a placement section 11 in which the paper sheet P that is an example of the medium to be transported is placed, the transport unit that is in contact with the paper sheet P uppermost in the stacking direction of the paper sheets P placed in the placement section 11 and transports the paper sheet P to the downstream side in the transport direction, the separation unit 12 that is provided on the downstream side of the transport unit, has the inclined surface 13 which is inclined with respect to the side view posture of the paper sheet P placed in the placement section 11, and separates the uppermost paper sheet with respect to the transport unit from the next and subsequent paper sheets when the top edges which are the downstream ends of the paper sheets P transported by the transport unit come into contact with the inclined surface 13, wherein the transport unit includes the pick-up roller 3 which is provided to be driven, is in contact with the paper sheet P placed in the placement section 11, and can be moved in the transport direction Y, as a counteracting force against a force applied by the driven pick-up roller 3 to the paper sheet P to transport the paper sheet P to the downstream side in the transport direction, a force (R) to move the pick-up roller 3 to the upstream side in the transport direction is applied from the paper sheet P to the pick-up roller 3, and when the counteracting force (R) becomes larger than a predetermined force (R1+R2 in the case of P2), the pick-up roller 3 is moved to the upstream side in the transport direction by the counteracting force.

Further, in this embodiment, the transport unit includes the arm mechanism 4 that rotatably holds the pick-up roller 3 at one end which is on the downstream side and swings around the swinging shaft 5 at the other end which is on the upstream side of the pick-up roller 3, the arm mechanism 4 is configured to change the distance L1 from the swinging shaft 5 which is the center of the swing movement to the pick-up roller 3, and the arm mechanism 4 further includes the urging unit 8 which, when the distance L1 is shorter than a distance in a state in which the pick-up roller 3 is at an initial position before the pick-up roller 3 is moved by the counteracting force, applies a force to extend the distance L1 of the arm mechanism 4 and return the pick-up roller 3 to the initial position.

Further, in this embodiment, the arm mechanism 4 includes the first arm section 6 that swings around the swinging shaft 5 that is the other end, and the second arm section 7 which is provided on the downstream side of the first arm section 6 in the transport direction, and whose upstream end is connected to the downstream end of the first arm section 6, and which rotatably holds the pick-up roller 3 at the downstream end, and the pick-up roller 3 moves to the upstream side in the transport direction by increasing an amount of bending at a portion where the first arm section 6 and the second arm section 7 are connected to each other.

Further, in this embodiment, as the urging unit 8 that applies a force to return the pick-up roller 3 to the initial position, the first spring section 9, which is a first spring that applies a force, when an amount of bending between the first arm section 6 and the second arm section 7 becomes large, in a direction to return a posture of the first arm section 6 on the upstream side to a posture when the amount of bending is small, is further provided.

Further, in this embodiment, as the urging unit 8 that applies a force to return the pick-up roller 3 to the initial position, the second spring section 10, which is a second spring that applies a force, when an amount of bending between the first arm section 6 and the second arm section 7 becomes large, in a direction to return a posture of the first arm section 6 and the second arm section 7 to a posture when the amount of bending is relatively small, is further provided.

Further, in this embodiment, the transport unit further includes the gear train section 22 which is a gear train that transmits power from the first arm section to the pick-up roller 3 of the second arm section, and the first arm section 6 and the second arm section 7 bend around the bend point K which is the center of the fourth gear 22d which is an Nth gear (N is an even number) counted from a gear of a shaft of the pick-up roller 3 including the gear of the shaft.

Further, in this embodiment, as the paper sheet P, the thin paper sheet P1 that is an example of a first medium and the thick paper sheet P2 that is an example of a second medium having a rigidity higher than that of the thin paper sheet P1 can be transported, and when a moment by the counteracting force which the pick-up roller 3 receives from the paper sheet P is defined as M1, a moment by a force applied to the first arm section 6 by a gear at a position where the first arm section 6 and the second arm section 7 bend is defined as M2, and a moment by a force that reduces an amount of bending between the first arm section 6 and the second arm section 7 is defined as M3, if the paper sheet is the thin paper sheet P1, the following relationship is established:

M3≧M1+M2,

and if the paper sheet is the thick paper sheet P2, the following relationship is established:

M3<M1+M2.

The printer 1 which is an example of the recording apparatus according to this embodiment includes the medium transport unit 2 that transports the paper sheet P which is an example of a medium to be recorded in the transport direction Y, and the recording section 16 that performs recording on the paper sheet P transported by the medium transport unit 2 by the recording head 18.

### Another Embodiment

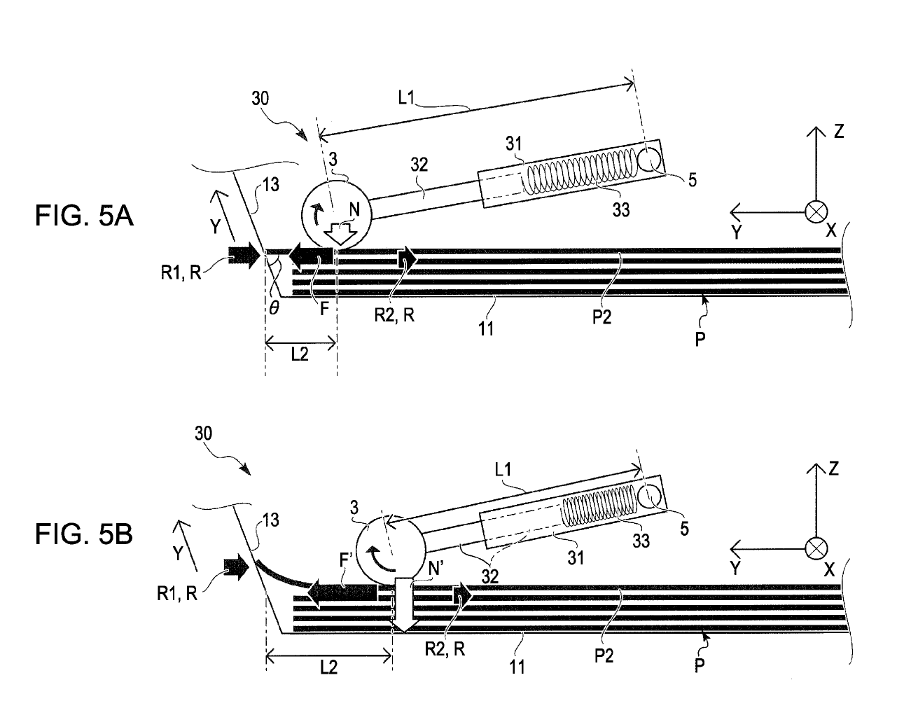

FIGS. 5A and 5B are side views showing an outline of a medium transport unit according to another embodiment. FIG. 5A shows a state in which the top edge of the thick paper sheet is in contact with the inclined surface. On the other hand, FIG. 5B shows a state in which the pick-up roller is slightly driven from the state of FIG. 5A.

As shown in FIGS. 5A and 5B, an arm mechanism 30 of the other embodiment includes a first arm section 31, a second arm section 32, and a third spring 33.

The other components are the same as those in the embodiment described above, so that the same reference characters are used and the description thereof are omitted.

The first arm section 31 is provided to be able to swing around the swinging shaft 5. The second arm section 32 is provided to be able to slide along the first arm section 31. In other words, the arm mechanism 30 is provided to be able to slidably extend and retract by the first arm section 31 and the second arm section 32. The pick-up roller 3 is provided on the downstream side of the second arm section 32. Further, the third spring 30 is provided to urge the arm mechanism 30 to extend.

The arm mechanism 30 is configured to extend and retract in a predetermined range.

Therefore, when the reaction force R1 becomes larger than a predetermined force, in the same manner as in the embodiment described above, the pick-up roller 3 can be moved to the upstream side in the transport direction.

Thus, although the arm mechanism 4 (see FIGS. 2 to 4) of the embodiment described above has a bending type structure, a sliding type structure such as the arm mechanism 30 of the other embodiment may be used. In a case of the sliding type structure, when using the thick paper sheet P2, it is possible to decrease the distance L1 from the swinging shaft 5 to the pick-up roller 3 and increase the distance L2 from the inclined surface 13 to the contact point between the pick-up roller 3 and the paper sheet P. As a result, the same operational effect can be obtained.

Regarding the power transmission to the pick-up roller 3, it is possible to provide a motor in the second arm section 32 to transmit power to the pick-up roller 3. It is also possible to transmit power from a motor provided in the base body to the pick-up roller 3 by means of a propeller shaft and a bevel gear. In this case, needless to say, the propeller shaft is configured to extend and retract in accordance with the slidable extension and retraction of the first arm section 31 and the second arm section 32 by combining two components.

Needless to say, the invention is not limited to the above embodiments, but various modifications can be made within a scope of the invention described in the claims, and these modifications are also included in the scope of the invention.

What is claimed is:

1. A medium transporting apparatus comprising:
a placement section where the medium are placed;
a transport unit that has a transport roller which is in contact with the medium placed in the placement section and located uppermost in a stacking direction and can be moved, and transports the medium to the downstream side by driving the transport roller; and
a separation unit that is provided on the downstream side of the transport unit, has an inclined surface which the top edges of the media placed in the placement section come into contact with, and separates the uppermost medium with respect to the transport unit from the next and subsequent media when the top edges of the media transported by the transport unit come into contact with the inclined surface,
wherein, as a counteracting force against a force for the transport roller to transport the medium to the downstream side, a force to move the transport roller to the upstream side in the transport direction is applied to the transport roller, and
when the counteracting force becomes larger than a predetermined force, the transport roller is moved from an initial position to the upstream side in the transport direction by the counteracting force.

2. The medium transporting apparatus according to claim 1, wherein
the transport unit includes an arm mechanism that rotatably holds the transport roller at one end and swings around the other end,
the arm mechanism is configured to change a distance from the center of the swing movement to the transport roller, and
the transport unit further includes a unit which, when the distance in a state in which the transport roller is moved by the counteracting force is shorter than the distance in a state in which the transport roller is at the initial position, applies a force to return the transport roller to the initial position.

3. The medium transporting apparatus according to claim 2, wherein
the arm mechanism includes
a first arm section that swings around the other end, and
a second arm section that swings around the transport roller, and
the transport roller moves to the upstream side in the transport direction by increasing an amount of bending at a portion where the first arm section and the second arm section are connected to each other.

4. The medium transporting apparatus according to claim 3, further comprising:
as a unit that applies a force to return the transport roller to the initial position,
a first spring that applies a force, when an amount of bending between the first arm section and the second arm section becomes large, in a direction to return a posture of the first arm section to a posture when the amount of bending is small.

5. The medium transporting apparatus according to claim 3, further comprising:
as a unit that applies a force to return the transport roller to the initial position,
a second spring that applies a force, when an amount of bending between the first arm section and the second arm section becomes large, in a direction to return a posture of the first arm section and the second arm section to a posture when the amount of bending is relatively small.

6. The medium transporting apparatus according to claim 3, wherein
the transport unit further includes a gear train that transmits power from the first arm section to the transport roller of the second arm section, and
the first arm section and the second arm section bend around an Nth gear (N is an even number) counted from a gear of a shaft of the transport roller including the gear of the shaft.

7. The medium transporting apparatus according to claim 6, wherein
as the medium, a first medium and a second medium having a rigidity higher than that of the first medium can be transported, and
when a moment by the counteracting force which the transport roller receives from the medium is defined as M1, a moment by a force applied to the first arm section by a gear at a position where the first arm section and the second arm section bend is defined as M2, and a moment by a force that reduces an amount of bending between the first arm section and the second arm section is defined as M3, the following relationship is established:
when the first medium is used,
M3≧M1+M2
and, when the second medium is used,
M3<M1+M2.

8. A recoding apparatus comprising:
the medium transporting apparatus according to claim 1, and
a recording section that performs recording on the medium transported by the medium transporting apparatus.

9. A medium transporting apparatus comprising:
a placement section where the medium are placed;
a transport unit that has a transport roller which is in contact with the medium placed in the placement section and located uppermost in a stacking direction and can be moved, and transports the medium to the downstream side by driving the transport roller; and
a separation unit that is provided on the downstream side of the transport unit, has an inclined surface which the top edges of the media placed in the placement section come into contact with, and separates the uppermost medium with respect to the transport unit from the next and subsequent media when the top edges of the media transported by the transport unit come into contact with the inclined surface,
wherein, as a counteracting force against a force for the transport roller to transport the medium to the downstream side, a force to move the transport roller to the upstream side in the transport direction is applied to the transport roller, and
when the counteracting force becomes larger than a predetermined force, a distance from a contact point at which the transport roller is in contact with the medium to the inclined surface increases.
